(19) United States
(12) Patent Application Publication
(10) Pub. No.: US 2013/0339040 A1
(43) Pub. Date: Dec. 19, 2013

(54) Selecting Secondary Patient Care

(71) Applicants: Michael Paul Bracken, Avon Lake, OH (US); James E. Lark, Lorain, OH (US)

(72) Inventors: Michael Paul Bracken, Avon Lake, OH (US); James E. Lark, Lorain, OH (US)

(73) Assignee: SelectCare Connect, LLC, Westlake, OH (US)

(21) Appl. No.: 13/527,538

(22) Filed: Jun. 19, 2012

(51) Int. Cl. G06Q 30/02; G06Q 50/22

(52) U.S. Cl. CPC G06Q 30/0201; G06Q 50/22
USPC 705/2

(57) ABSTRACT

One or more techniques and/or systems are disclosed for selecting a secondary care facility. Secondary care facility data can be collected and stored in a facility database. Received patient care data can be compared with the secondary care facility data in the facility database, resulting in a set of one or more secondary care facility identifiers, which can be provided to a patient representative. The patient representative may select at least one of the identified secondary care facilities presented, based on secondary care facility data provided to the patient representative. The selection made by the patient representative along with selection criteria data, such as a selection process and data provided, can be stored in an auditing database for later retrieval as desired.

### BACKGROUND

After a patient receives primary care services, such as in a clinic or hospital, and after immediate post-treatment care at the primary care facility, the patient is often discharged to a secondary care facility where appropriate continued treatment and/or care may be provided. As an example, after a serious accident, the patient may receive immediate emergency care at a hospital, as well as immediate post treatment recovery. In this example, after a period of time, the patient may be discharged to an extended care facility that can provide continued recovery therapy, and post treatment care. Often, a government agency, private insurer, and/or other entity may wish to audit the post discharge, secondary care facility referral process. Sometimes, there may be a referral bias in place at primary care facilities, for example, where preferred secondary care facilities may be referred over others. An audit of the secondary care selection process may illuminate cases of referral steering.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Some post discharge systems, such as web-based systems, allowing nursing homes, home health agencies, hospices, rehab facilities, and other extended care organizations to track and manage inbound patient referrals, the patient's medical documents, and other information, thereby automating a referral management process. Typically, referrals from discharge planners in primary care facilities can be tracked and processed by the secondary care facility, also allowing documents associated with a referral to be managed, as well as the patient check-in process. However, current and previous techniques and systems may not provide for an unbiased referral process, and/or may not allow for an easy and unbiased auditing process.

Accordingly, among other things, one or more techniques and/or systems are disclosed for offering a one-stop solution that can provide appropriate information to assist a patient consumer in making an informed, unbiased selection of an appropriate and available extended care facility matched to their specific needs. For example, real time information about the potential secondary care facilities may be proved to the consumer patient. Further, a method and/or system use may comprise a remote (e.g., cloud-based) application for consumers and primary care facility discharge planners that provides relevant content to consumers and discharge planners regarding secondary care facilities (e.g., extended care facilities) based on accessibility, services, amenities, affordability and quality of care. Additionally, easy, unbiased auditing of the patient post primary care discharge to secondary care facilities may be performed, by providing documentation of the patient's secondary care facility selection, for example.

In one embodiment of selecting a secondary care facility, a set of one or more secondary care facility identifiers can be provided to a patient representative (e.g., patient and/or discharge planner), where the set can be identified by comparing patient data to secondary care facility data that may be indexed in a secondary care facility database. Further, a patient representative selection may be received, where the selection corresponds to at least one of the secondary care facility identifiers in the set. Additionally, the patient representative selection and selection criteria data can be stored in an auditing database.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### DESCRIPTION OF THE DRAWINGS

FIG. 1 is a flow diagram illustrating an exemplary method for selecting a secondary care facility.

FIG. 2 is a flow diagram illustrating an example embodiment where one or more portions of one or more techniques described herein may be implemented.

FIG. 3 is a flow diagram illustrating an example embodiment where one or more portions of one or more techniques described herein may be implemented.

FIG. 4 is an illustration of an example embodiment where one or more portions of one or more techniques described herein may be implemented.

FIG. 5 is a component diagram illustrating an exemplary system for selecting a secondary care facility.

FIG. 6 is a component diagram illustrating an example embodiment where one or more portions of systems described herein may be implemented.

FIG. 7 is an illustration of an exemplary computer-readable medium comprising processor-executable instructions configured to embody one or more of the provisions set forth herein.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

As provided herein, a method may be devised that allows a patient representative (e.g., a patient, the patient's designated representative, a hospital administrator, etc.) to easily select an appropriate secondary care (e.g., extended care) facility, such prior to or after discharge from a hospital. Further, the selection process provides for an unbiased secondary care facility identification process, for example, where the facilities may be identified based on patient needs, and/or desired selection criteria. In this way, for example, a secondary care facility selection process may be easily audited, and primary care facilities (e.g., hospitals) may reduce a liability of appearing to be biased toward referring patients to particular facilities.

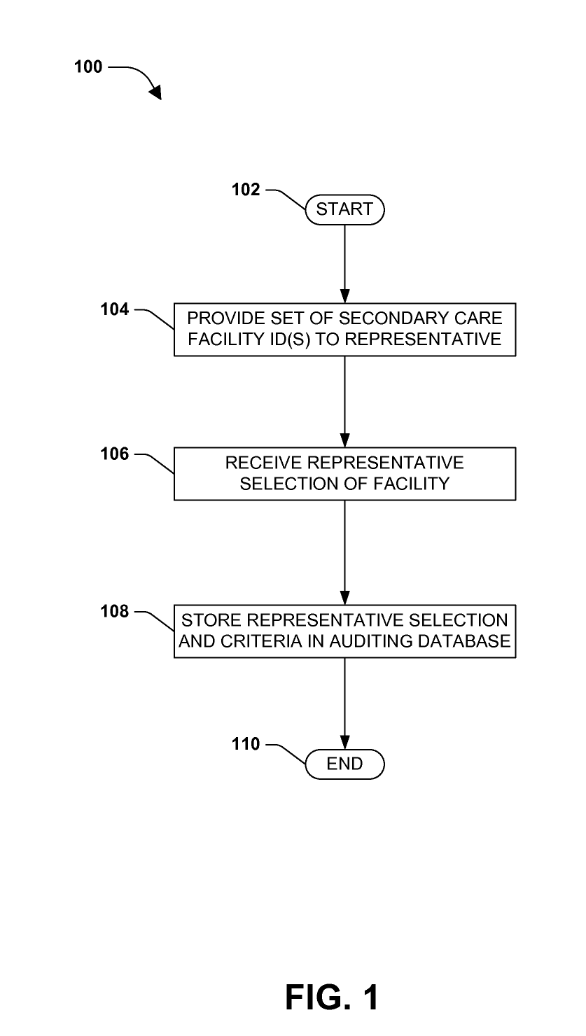

FIG. 1 is a flow diagram illustrating an exemplary method 100 for selecting a secondary care facility. The exemplary method 100 begins at 102. At 104, a set of one or more secondary care facility identifiers is provided to a patient representative, such as the patient themselves, and/or an appropriately appointed representative of the patient. Here, the set of one or more secondary care facility identifiers is identified by comparing patient data to secondary care facility data indexed in a secondary care facility database.

In one embodiment, patient data can comprise patient care needs, such a clinical treatment needs, special needs, or other needs that may facilitate treatment of the patient. Further, the patient data can comprise a patient's payor source, such as insurance information or other funding sources. Additionally, the patient data may comprise one or more desired secondary care facility locations (e.g., close to family and/or friends); and/or one or more desire secondary care facility amenities (e.g., food, social, religion, size, recreations, etc.). The patient data may also comprise a desired secondary care facility rating range (e.g., based on a rating service, other patient customers, government ratings, etc.); and/or a desired secondary care facility cost range.

In one embodiment, the secondary care facility data can comprise a secondary care facility identifier, such as a name or other identifier (e.g., government ID number), and/or a facility location. Further, the secondary care facility data can comprise one or more secondary care facility accepted payor sources (e.g., insurance accepted by the facility); one or more secondary care facility services; one or more secondary care facility clinical capabilities; and/or one or more secondary care facility amenities. Additionally, the secondary care facility data can comprise a secondary care facility cost indicator (e.g., a range of costs associated with various situations); a facility rating; and/or a facility capacity (e.g., beds, service capacity, clinical capability capacity, etc.). In this way, for example, the patient data may be matched with appropriate facility data to determine the appropriate facilities for the patient.

At 106 in the exemplary embodiment 100, a patient representative selection is received, where the selection corresponds to at least one of the secondary care facility identifiers in the set. That is, for example, the returned set of identified secondary care facilities may comprise those that match the patient criteria (e.g., or a desired portion thereof). In one embodiment, the patient representative may peruse the set of identified facilities and select a desired facility (e.g., based on more detailed information about the facility).

At 108, the patient representative selection, along with selection criteria data, is stored in an auditing database. As one example, selection criteria information used and/or provided to the patient during the selection process may comprise the patient data, the secondary care facility data, and/or additional information accessed by the patient about respective identified facilities. The selection criteria information and the patient's actual facility selection can be stored in an auditing database, for example, such that the information may be retrieved at a later time (e.g., when the facility selection process is audited).

Having stored the representative selection and selection criteria in the auditing database, the exemplary method 100 ends at 110.

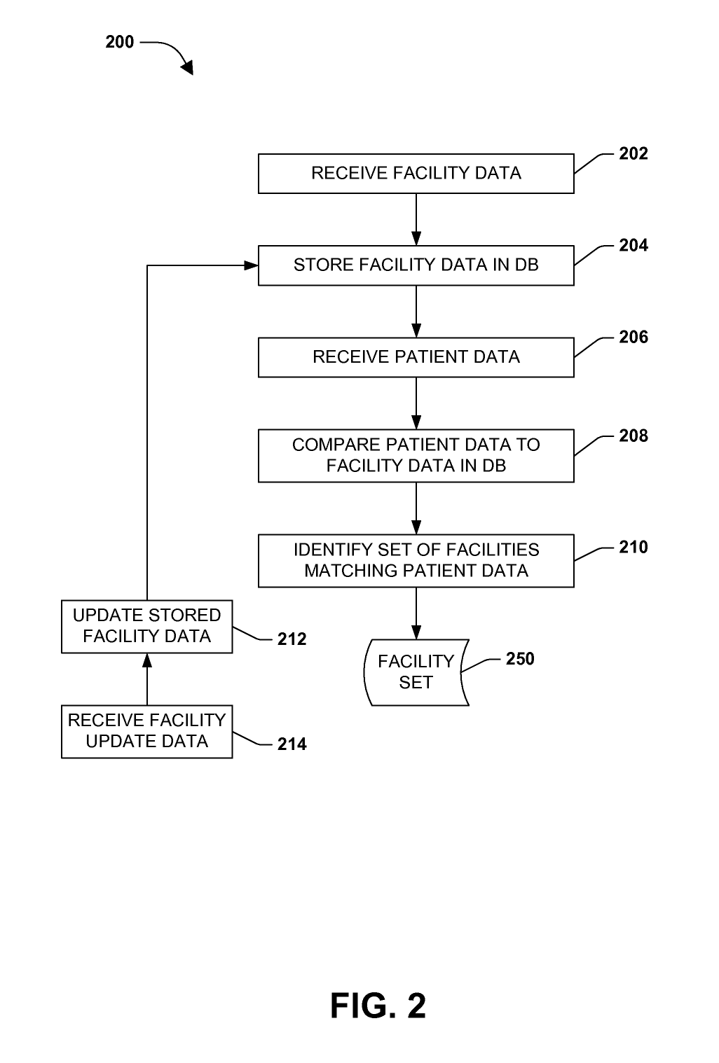

FIG. 2 is a flow diagram illustrating an example embodiment 200 where one or more portions of one or more techniques described herein may be implemented. At 202, secondary care facility data can be received. As an example, a secondary care facility may comprise a health care providing facility, and/or extended care facility used by a patient after discharge from a primary care facility (e.g., hospital or clinic). As an illustrative example, a patient may be admitted to a hospital for treatment, such as for surgery and post-surgery recovery. In this example, the patient may further need longer term therapy and/or recovery, which can be accommodated by an extended care facility (e.g., in a more comfortable, and typically less costly environment).

In one embodiment, secondary care facilities may comprise an extended care facility (e.g., clinical), a nursing home, a skilled nursing facility, home health care, hospice, assisted living, and/or an independent living facility. For example, a primary care facility, such as a hospital or clinic, will discharge patients to these types of facilities for follow-up care and/or treatment. In one embodiment, the secondary care facility data may be provided by the facility, and/or may be retrieved from available data. Further, in one embodiment, the secondary care facility data may be verified, for example, to determine whether the received data represents actual conditions for the facility (e.g., ratings, availability of services, amenities, costs, capabilities, etc.).

At 204 in the example embodiment 200 of FIG. 2, the secondary facility data can be stored and indexed in a secondary care facility database. In one embodiment, one or more portions of the secondary care facility database may be comprised in a remote storage system (e.g., cloud server), for example, and access to the remote storage system may be made by way of a remote connection over a network (e.g., the Internet). In one embodiment, one or more portions of the secondary care facility database may be stored locally (e.g., on a local machine), for example, and access to the local storage system may be made by way of a locally connected machine (e.g., computer).

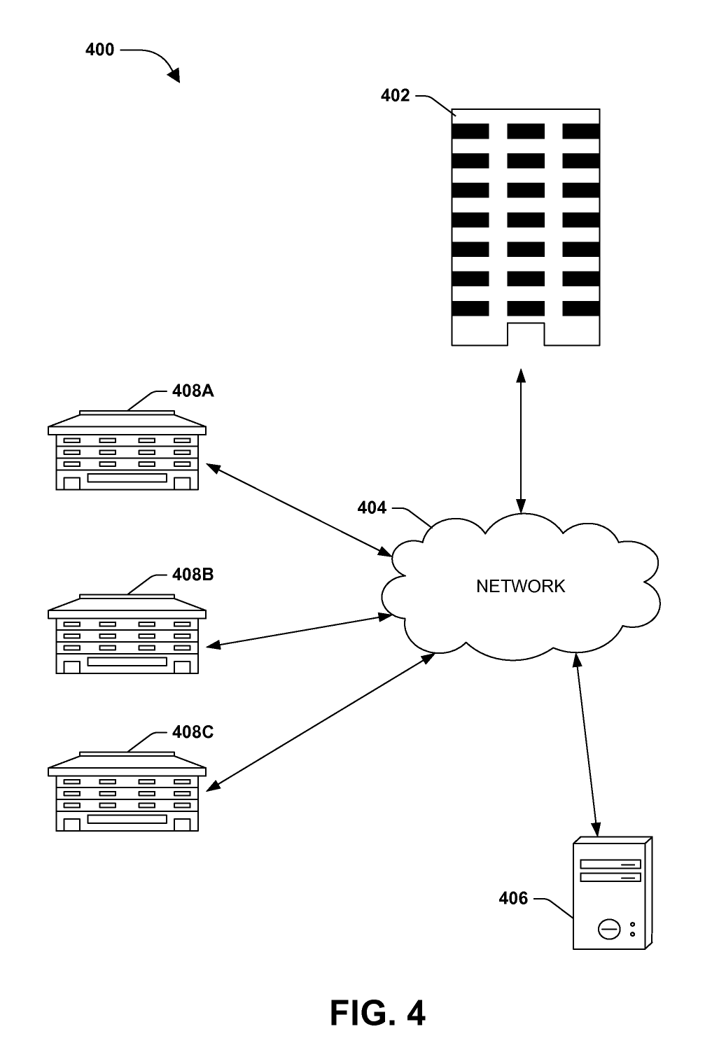

As an illustrative example, FIG. 4 is an illustration of an example embodiment 400, where one or more portions of one or more techniques described herein may be implemented. In this example, one or more secondary care facilities 408A, 408B, 408C may send their associated secondary care facility data (e.g., or the data may be pulled from them) over a network connection 404 (e.g., the Internet or an intranet) to a remote server 406 (e.g., a cloud-based server). In this example, the remote server may comprise portions of the secondary care facility database, where the secondary care facility data may be indexed (e.g., and stored).

Returning to FIG. 2, at 214, updated secondary care facility data may be received, and the updated facility data can be stored in the secondary care facility database (e.g., update the data in the database). In one embodiment, the updated facility data may be received in “real-time”, for example, where the data is received upon being updated by the facility, such as where bed availability changes occur. In another embodiment, the updated facility data may be received periodically, for example, at pre-determined updating periods. As an illustrative example, in FIG. 4, a secondary care facility 408A may have discharged a patient, and the updated availability of the newly opened bed can be automatically sent over the network 404 to the remote server system 406 to update the secondary care facility database.

In one embodiment, the update to the secondary care facility data may indicate an updated availability of the one or more secondary care facility services, such as newly added service or services that may not be currently available. The update to the secondary care facility data may indicate an updated availability of the one or more secondary care facility clinical capabilities, such as newly added clinical capabilities (e.g., a new medical machine) or capabilities that may not be currently available (e.g., due to staff vacation, etc.). The update to the secondary care facility data may indicate an updated secondary care facility capacity, such as patient space (e.g., bed space) availability.

At 206 in the example embodiment 200 of FIG. 2, the patient data can be received. In one embodiment, a patient data entry user interface may be provided, such as on a computing device (e.g., desktop, laptop, tablet, mobile device), that allows the patient representative to enter the patient data. In one embodiment, the patient data entry user interface may comprise an application that is based on a remote server system (e.g., a web-based application), and/or an application that is based on a local machine (e.g., used by the patient representative). As one example, the patient data entry user interface may allow the patient (e.g., or appropriate representative) to enter data that can be used to match with the secondary care facility data.

As described above, the patient data can comprise patient care needs, such a clinical treatment needs, special needs, or other needs that may facilitate treatment of the patient; a patient's payor source, such as insurance information or other funding sources; one or more desired secondary care facility locations (e.g., close to family and/or friends); and/or one or more desire secondary care facility amenities (e.g., food, social, religion, size, recreations, etc.); a desired secondary care facility rating range (e.g., based on a rating service, other patient customers, government ratings, etc.); and/or a desired secondary care facility cost range.

At 208 in the example embodiment 200, the received patient data can be compared to the secondary care facility data indexed in the secondary care facility database (e.g., updated). At 210, a result of the comparison can comprise a set 250 of one or more secondary care facility identifiers, where the respective one or more secondary care facility identifiers may be linked to the secondary care facility data. That is, for example, a list of matching (e.g., matching the patient data) secondary care facilities can be retrieved from the secondary care facility database.

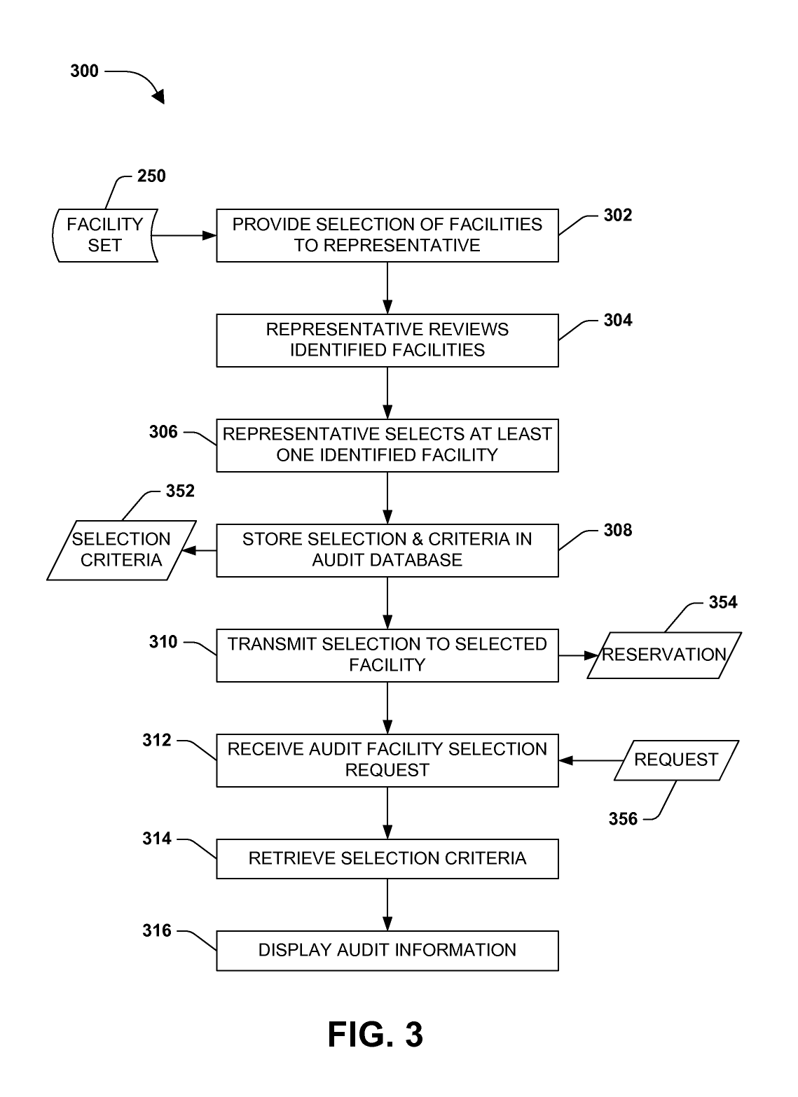

FIG. 3 is a flow diagram illustrating an example embodiment 300 where one or more portions of one or more techniques described herein may be implemented. At 302, a set 250 of the one or more secondary care facility identifiers can be presented to the patient representative (e.g., patient and/or appropriate patient representative). In one embodiment, the set of identifiers can be provided using a patient representative facility selection user interface. In this embodiment, the patient representative facility selection user interface can provide information associated with the one or more secondary care facility identifiers in the set, based on the secondary care facility data. In one embodiment, the user interface may be a remote-based service (e.g., web-app), and/or may comprise a local application.

For example, the set of secondary care facilities that have been identified as matching the patient data (e.g., based on patient care needs, costs, payor, amenities, location, rating, etc.) can be presented to the patient (e.g., or representative) in a user interface. In one embodiment, the information about the secondary care facilities may comprise a list of respective secondary care facility data, such as amenities, facilities, capabilities, costs, location, etc. In one embodiment, the information about the secondary care facility may comprise multi-media presentation, such as pictures, videos, interactive walk-throughs, video-conferences, chat sessions, etc. In one embodiment, the information about the secondary care facilities may comprise a searchable database associated with a second secondary care facility, where the searchable database comprises secondary care facility data that is linked to the second secondary care facility.

At 306 in the example embodiment 300, the patient representative selects at least one of the secondary care facilities identified (e.g., as matching the patient data, at least partially). At 308, the patient representative selection can be stored in an auditing database, along with the selection criteria 352. In one embodiment, storing the selection criteria can comprise storing the secondary care facility selected by the patient representative; the patient data that may have been used to identify the set of one or more secondary care facility identifiers; the secondary care facility data that was used to identify the set of one or more secondary care facility identifiers; and/or the secondary care facility information that was provided to the patient representative, where the secondary care facility information is associated with the one or more secondary care facility identifiers in the set 250.

At 310, the selection of a secondary care facility may result in at least a portion of the patient data being transmitted to the selected secondary care facility. In one embodiment, the transmittal of the patient data may result in a reservation for the patient at the selected secondary care facility. As an example, upon selection of the secondary care facility by the patient, the patient's appropriate information (e.g., name, personal data, clinical needs, service preferences, etc.) can be sent to the selected facility, which may automatically reserve the selected service (e.g., room, treatments, etc.) for the patient. In this way, as an example, upon discharge from the hospital, the patient may be immediately transported to the selected secondary care facility, where the desired services can be ready.

As an illustrative example, in FIG. 4, the patient may be preparing to be discharged from a primary care facility 402 (e.g., hospital), where a discharge manager may be helping the patient prepare. At the primary care facility 402, the patient (e.g., or representative, discharge manager) may access a cloud-based service 406 (e.g., web-app) over the Internet 404, which allows them to input the appropriate patient data. In this example, the cloud-based service 406 can match the patient data to appropriate secondary care facilities 408, using the facility data stored (e.g., and updated) in a database. The cloud-based service can provide a list of secondary care facilities 408 to the patient, who may select one 408B, based on provided information. At the hospital, upon selection of the secondary care facility 408B, a reservation request may be transmitted to the secondary care facility 408B over the Internet. The facility 408B can prepare for receiving the patient, who can be then discharged from the primary care facility 402.

Returning to FIG. 3, at 312, a request 356 for a facility selection audit may be received. As one example, primary care facilities may be inclined to refer patients to preferred secondary care facilities (e.g., partner facilities). Some government agencies, and private insurers, do not prefer this type of “guided” referral practice, which may cause great liability for the primary care facilities. Further, improper treatment at a secondary care facility may also lead to increased liability for a referring facility, if the referral was “guided”. In one embodiment, use of the secondary care selection systems and techniques, described herein, can result in an unbiased selection process, for example, where the patient's choice is clearly their own (e.g., based on available data).

At 314, the patient's selection criteria 352, which was stored in the auditing database, can be retrieved, and displayed (e.g., to the audit requestor), at 316. As an example, an auditor may wish to determine whether a patient (e.g., or set of patients) has been “guided” to a preferred partner of a hospital. In this example, the auditor can request secondary care selection records for the patient, and the selection criteria, including the actual selection, patient data used, secondary care facility data used, and/or information presented to the patient during the selection process, can be automatically retrieved from the auditing database. In this way, for example, the auditor may be able to determine that the patient (e.g., or representative) was presented appropriate choices, was presented appropriate information, and made a free-will choice in their selection of the secondary care facility.

Further, for example, the auditing database may comprise information that indicates mitigated instances of preferential facility selection. That is, for example, respective secondary care facilities that comprise facility data in the facility database may have no preferential treatment when it comes to selection. The set of one or more secondary care facilities presented to the patient, for example, can comprise merely those whose facility data matches (e.g., at least partially) the patient data. Therefore, for example, large, well-known facilities may have a same advantage as smaller, lesser-known facilities where the facility data is similar.

A system may be devised that allows a patient (e.g., or patient representative) to receive unbiased secondary care facility selection information, based merely on the patient needs and preferences. For example, a secondary care facility, such as an extended care facility, may be identified based on matching the patient needs and preferences to stored facility information. The list of matching facilities may be presented to the patient, who may select their preferred facility based on additional information. In this way, for example, a secondary care facility selection process may be easily audited, and primary care facilities (e.g., hospitals) may reduce a liability of appearing to be biased toward referring patients to particular facilities.

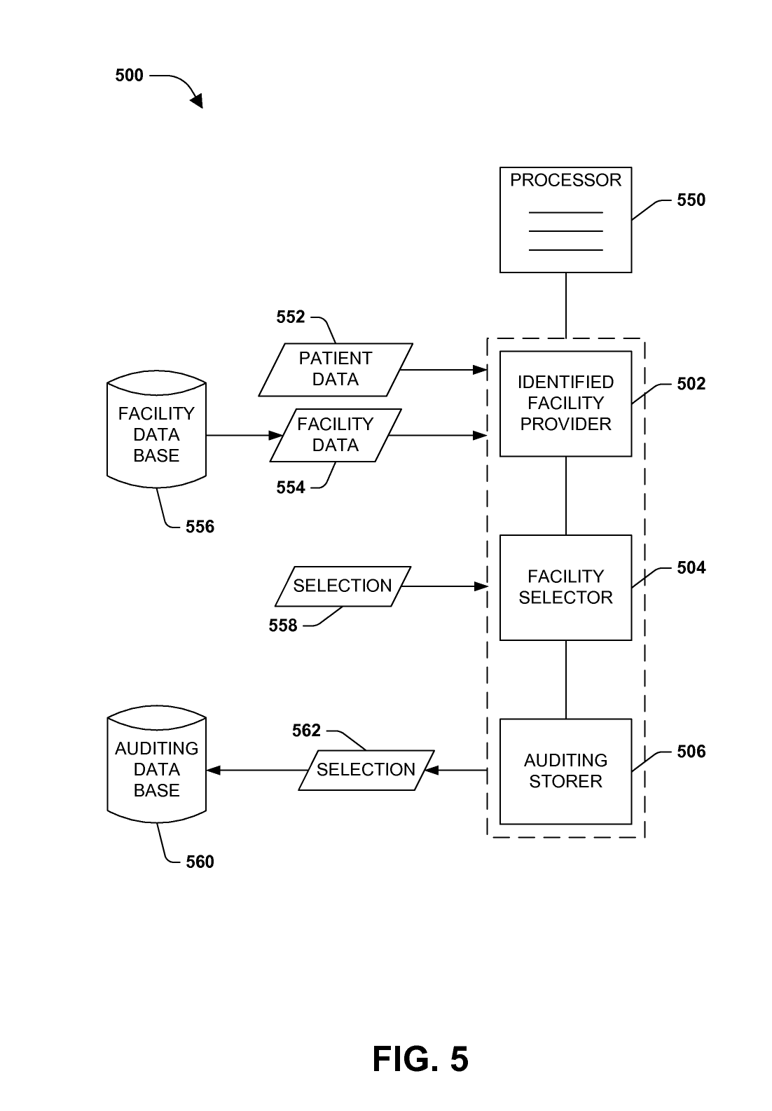

FIG. 5 is a component diagram illustrating an exemplary system 500 for selecting a secondary care facility. In the exemplary system 500, an identified facility providing component 502 is configured to compare patient data 552 to secondary care facility data 554 that is indexed in a secondary care facility database 556. A result of the comparing comprises a set of one or more secondary care facility identifiers, for example, identifying secondary care facilities that may match the patient needs and/or preferences. Further, the identified facility providing component 502 is configured to provide the set of the one or more secondary care facility identifiers to a patient representative. For example, the identified secondary care facilities that may match the patient needs and/or preferences can be provided (e.g., displayed) to the patient (e.g., or appropriate representative).

In the exemplary system 500, a facility selection component 504 is operably coupled with the identified facility providing component 502. The facility selection component 504 is configured to receive a patient representative selection 558 that corresponds to at least one of the secondary care facility identifiers in the set. Further, an auditing storage component 506 is operably coupled with the facility selection component, and is configured to store the patient representative selection 558 and selection criteria data 562 in an auditing database 560. In the exemplary system 500, at least a portion of the system 500 is implemented, at least in part, via a processing unit 550.

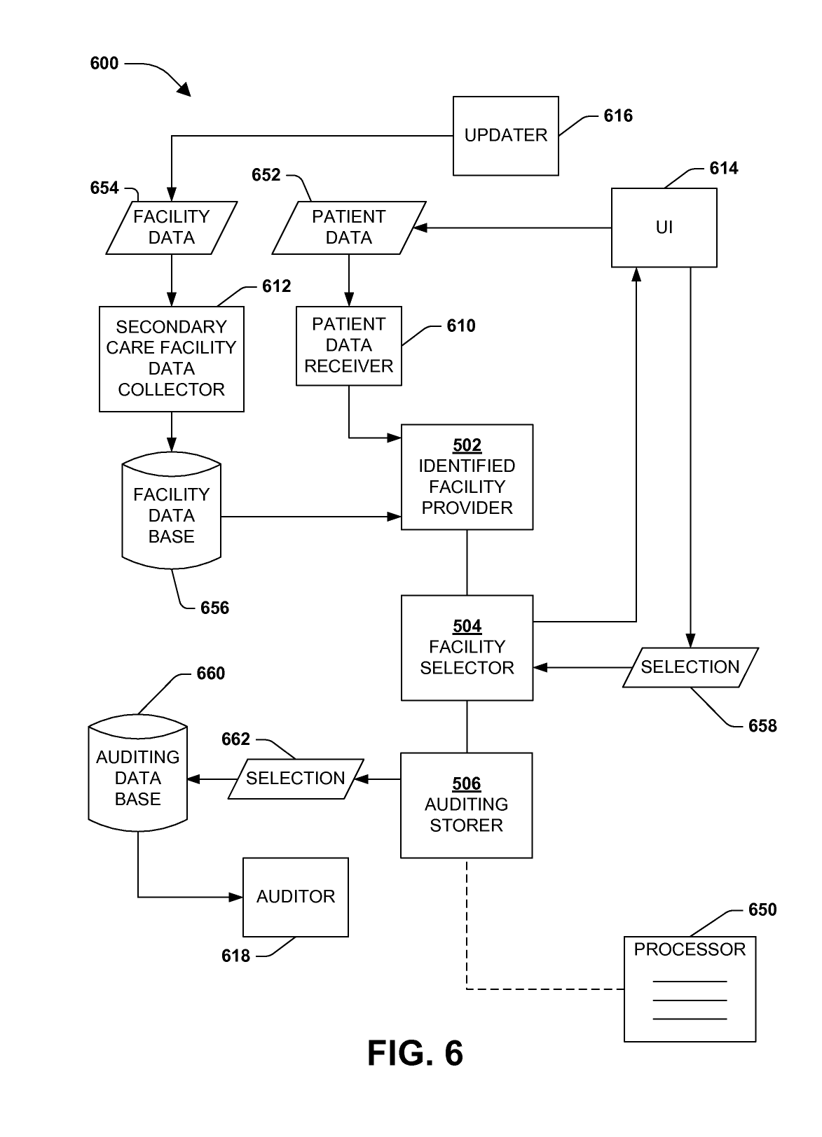

FIG. 6 is a component diagram illustrating an example embodiment 600 where one or more portions of systems described herein may be implemented. In this example 600, an extension of FIG. 5 is provided and thus description of elements, components, etc. described with respect to FIG. 5 may not be repeated for simplicity. In the example embodiment 600, a patient data receiving component 610 is configured to receive the patient data 652.

In one embodiment, the patient data 652 can comprise patient care needs, such a clinical treatment needs, special needs, or other needs that may facilitate treatment of the patient. Further, the patient data 652 can comprise a patient's payor source, such as insurance information or other funding sources. Additionally, the patient data 652 may comprise one or more desired secondary care facility locations (e.g., close to family and/or friends); and/or one or more desire secondary care facility amenities (e.g., food, social, religion, size, recreations, etc.). The patient data 652 may also comprise a desired secondary care facility rating range (e.g., based on a rating service, other patient customers, government ratings, etc.); and/or a desired secondary care facility cost range.

In the example embodiment 600, a secondary care facility data collecting component 612 can be configured to collect the secondary care facility data 654. In one embodiment, the secondary care facility data 654 can comprise a secondary care facility identifier, such as a name or other identifier (e.g., government ID number), and/or a facility location. Further, the secondary care facility data 654 can comprise one or more secondary care facility accepted payor sources (e.g., insurance accepted by the facility); one or more secondary care facility services; one or more secondary care facility clinical capabilities; and/or one or more secondary care facility amenities. Additionally, the secondary care facility data 654 can comprise a secondary care facility cost indicator (e.g., a range of costs associated with various situations); a facility rating; and/or a facility capacity (e.g., beds, service capacity, clinical capability capacity, etc.).

The example embodiment 600 comprises a user interface component 614. In one embodiment, the user interface component 614 can be configured to provide a patient data input interface, and/or receive an indication of patient data input, for example, such that the patient and/or appointed patient representative may input appropriate patient data 652 (e.g., to match to the facility data). The user interface component 614 may also be configured to display the provided set of one or more secondary care facility identifiers to a patient representative, and/or display facility information associated with the one or more secondary care facility identifiers to a patient representative. In this way, the patient may be able to review the identified secondary care facility information to make an informed choice for their selection.

Further, the user interface component 614 may be configured to receive an indication of a patient representative selection input. For example, the patient may select a secondary care facility from a list of identified facilities, and the selection may be stored 662 in the auditing database 660. The user interface component 614 may also be configured to receive an indication of a patient selection audit request input, and/or display audit information associated with the patient selection audit request input.

In the example embodiment 600 of FIG. 6, an updating component 616 can be configured to update the secondary care facility data 654 in real-time. For example, facility data 654 may be received by the updating component 616 upon being updated by the facility, and/or updated facility data 654 may be received periodically, for example, at pre-determined updating periods. In one embodiment, the update to the secondary care facility data 654 may indicate an updated availability of the one or more secondary care facility services, clinical capabilities, and/or updated secondary care facility capacity.

The example embodiment 600 of FIG. 6 comprises an auditing component 618 that may be configured to provide an audit of a secondary care facility selection process. In one embodiment, the audit of a secondary care facility selection process can comprise retrieving the patient representative selection and selection criteria data 662 from the auditing database 618. In this way, for example, the unbiased and informed patient selection of the secondary care facility may be provided to an audit requestor (e.g., in the user interface 614).

In one embodiment, portions of the example system 600 may comprise a remote network-based application (e.g., we-app) that may be accessed over a network (e.g., 404 of FIG. 4). Further, portions of the example system 600 may comprise a remote storage component (e.g., 406 of FIG. 4) that can be configured to store and retrieve database information, such as information in the secondary care facility database, and/or information in the auditing database. In one embodiment, portions of the example system 600 may comprise a local application that can be accessed locally on a computing device.

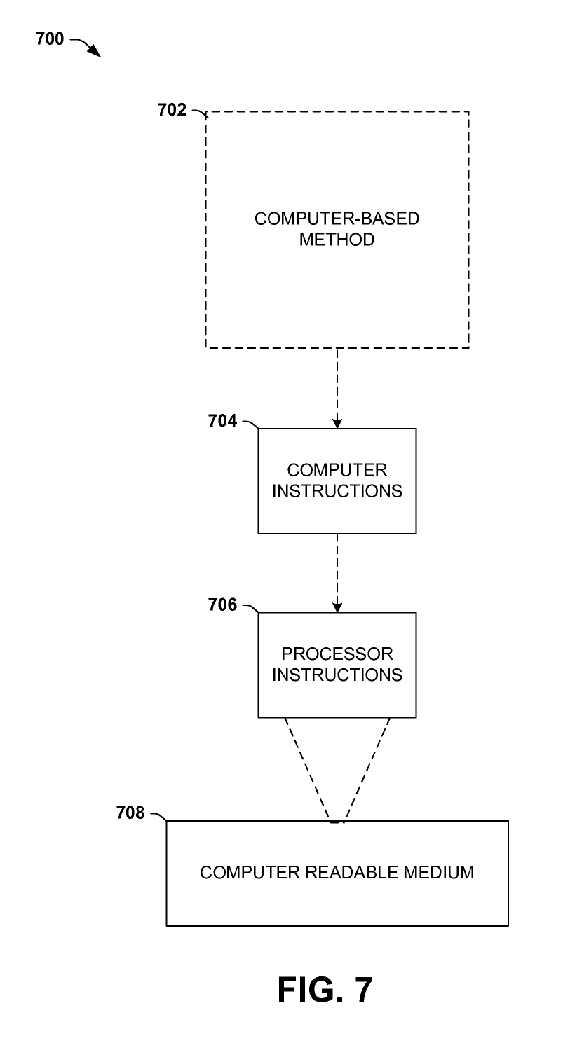

Still another embodiment involves a computer-readable medium comprising processor-executable instructions configured to implement one or more of the techniques presented herein. An exemplary computer-readable medium that may be devised in these ways is illustrated in FIG. 7, wherein the implementation 700 comprises a computer-readable medium 708 (e.g., a CD-R, DVD-R or a platter of a hard disk drive), on which is encoded computer-readable data 706. This computer-readable data 706 in turn comprises a set of computer instructions 704 configured to operate according to one or more of the principles set forth herein. In one such embodiment 702, the processor-executable instructions 704 may be configured to perform a method, such as at least some of the exemplary method 100 of FIG. 1, for example. In another such embodiment, the processor-executable instructions 704 may be configured to implement a system, such as at least some of the exemplary system 500 of FIG. 5, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

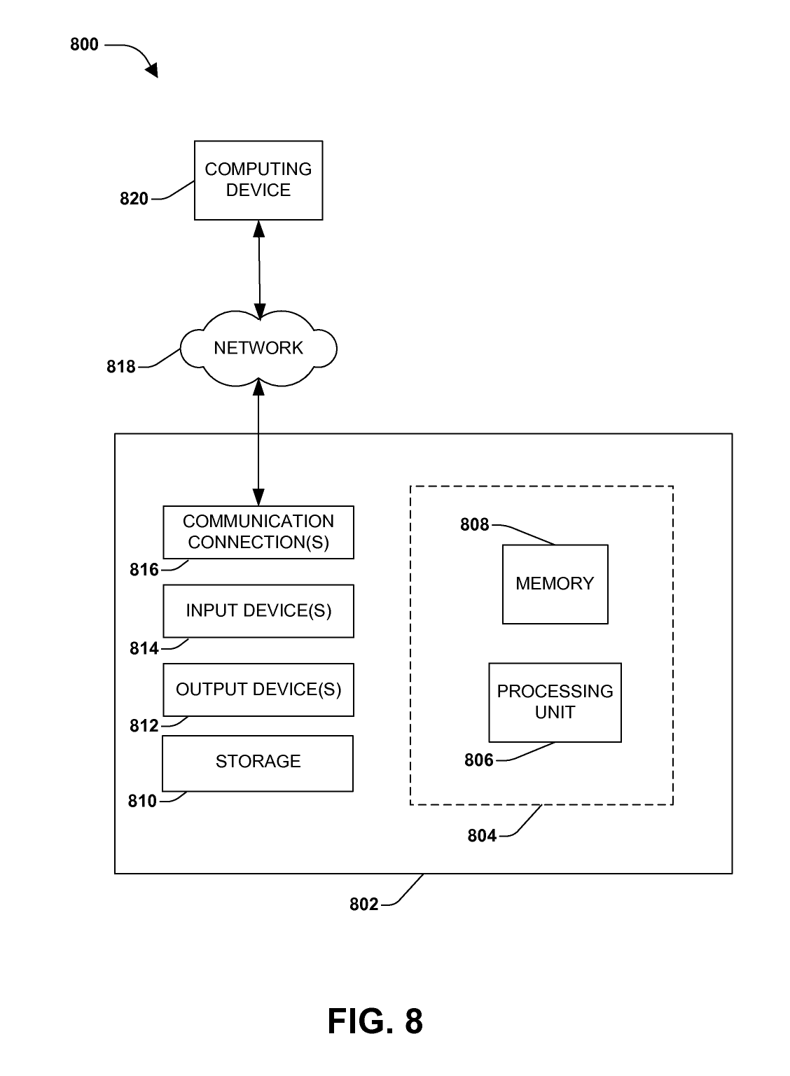

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 802 configured to implement one or more embodiments provided herein. In one configuration, computing device 802 includes at least one processing unit 806 and memory 808. Depending on the exact configuration and type of computing device, memory 808 may be volatile (such as RAM, for example), non-volatile (such as ROM, flash memory, etc., for example) or some combination of the two. This configuration is illustrated in FIG. 8 by dashed line 804.

In other embodiments, device 802 may include additional features and/or functionality. For example, device 802 may also include additional storage (e.g., removable and/or non-removable) including, but not limited to, magnetic storage, optical storage, and the like. Such additional storage is illustrated in FIG. 8 by storage 810. In one embodiment, computer readable instructions to implement one or more embodiments provided herein may be in storage 810. Storage 810 may also store other computer readable instructions to implement an operating system, an application program and the like. Computer readable instructions may be loaded in memory 808 for execution by processing unit 806, for example.

The term “computer readable media” as used herein includes computer storage media. Computer storage media includes volatile and nonvolatile, removable and non-removable media implemented in any method or technology for storage of information such as computer readable instructions or other data. Memory 808 and storage 810 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 802. Any such computer storage media may be part of device 802.

Device 802 may also include communication connection(s) 816 that allows device 802 to communicate with other devices. Communication connection(s) 816 may include, but is not limited to, a modem, a Network Interface Card (NIC), an integrated network interface, a radio frequency transmitter/receiver, an infrared port, a USB connection or other interfaces for connecting computing device 802 to other computing devices. Communication connection(s) 816 may include a wired connection or a wireless connection. Communication connection(s) 816 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 802 may include input device(s) 814 such as keyboard, mouse, pen, voice input device, touch input device, infrared cameras, video input devices, and/or any other input device. Output device(s) 812 such as one or more displays, speakers, printers, and/or any other output device may also be included in device 802. Input device(s) 814 and output device(s) 812 may be connected to device 802 via a wired connection, wireless connection, or any combination thereof. In one embodiment, an input device or an output device from another computing device may be used as input device(s) 814 or output device(s) 812 for computing device 802.

Components of computing device 802 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 802 may be interconnected by a network. For example, memory 808 may be comprised of multiple physical memory units located in different physical locations interconnected by a network.

Those skilled in the art will realize that storage devices utilized to store computer readable instructions may be distributed across a network. For example, a computing device 820 accessible via network 818 may store computer readable instructions to implement one or more embodiments provided herein. Computing device 802 may access computing device 820 and download a part or all of the computer readable instructions for execution. Alternatively, computing device 802 may download pieces of the computer readable instructions, as needed, or some instructions may be executed at computing device 802 and some at computing device 820.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A computer based method for selecting a secondary care facility, comprising:
providing a set of one or more secondary care facility identifiers to a patient representative, the set identified by comparing patient data to secondary care facility data indexed in a secondary care facility database;
receiving a patient representative selection corresponding to at least one of the secondary care facility identifiers in the set; and
storing the patient representative selection and selection criteria data in an auditing database, at least a portion of the method implemented at least in part via a processing unit.

2. The method of claim 1, comprising receiving the patient data, the patient data comprising one or more of:
patient care needs;
a patient payor source;
one or more desired secondary care facility locations;
one or more desired secondary care facility amenities;
a desired secondary care facility rating range; and
a desired secondary care facility cost range.

3. The method of claim 2, comprising providing a patient data entry user interface that allows the patient representative to enter the patient data, the patient data entry user interface comprising one or more of:
at least a portion of a remote network-based application; and
at least a portion of a locally accessed application.

4. The method of claim 1, comprising collecting the secondary care facility data, the secondary care facility data comprising one or more of:
a secondary care facility identifier;
a secondary care facility location;
one or more secondary care facility accepted payor sources;
one or more secondary care facility services;
one or more secondary care facility clinical capabilities;
one or more secondary care facility amenities;
a secondary care facility cost indicator;
a secondary care facility rating; and
a secondary care facility capacity.

5. The method of claim 1, comprising storing the secondary care facility data indexed in the secondary care facility database on one or more of:
remote storage; and
local storage.

6. The method of claim 4, comprising receiving an update to the secondary care facility data indicating one or more of:
an updated availability of the one or more secondary care facility services;
an updated availability of the one or more secondary care facility clinical capabilities; and
an updated secondary care facility capacity.

7. The method of claim 1, comprising comparing received patient data to the secondary care facility data indexed in the secondary care facility database, resulting in the set of the one or more secondary care facility identifiers, the respective one or more secondary care facility identifiers linked to the secondary care facility data.

8. The method of claim 1, providing a set of one or more secondary care facility identifiers to a patient representative comprising providing a patient representative facility selection user interface, the patient representative facility selection user interface providing information associated with the one or more secondary care facility identifiers in the set based on the secondary care facility data.

9. The method of claim 8, the information associated with the one or more secondary care facility identifiers comprising one or more of:
one or more multi-media presentations associated with a first secondary care facility; and
a searchable database associated with a second secondary care facility, the searchable database comprising at least secondary care facility data linked to the second secondary care facility.

10. The method of claim 1, storing the patient representative selection and selection criteria data in an auditing database comprising storing one or more of:
a secondary care facility selected by the patient representative;
the patient data used to identify the set of one or more secondary care facility identifiers;
the secondary care facility data used to identify the set of one or more secondary care facility identifiers; and
secondary care facility information provided to the patient representative, the secondary care facility information associated with the one or more secondary care facility identifiers in the set.

11. The method of claim 1, comprising transmitting at least a portion of the patient data to a third secondary care facility associated with the patient representative selection, resulting in a patient reservation at the third secondary care facility.

12. The method of claim 1, comprising retrieving the patient representative selection and selection criteria data from the auditing database.

13. A computer-based system for selecting a secondary care facility, comprising:
an identified facility providing component configured to:
compare patient data to secondary care facility data indexed in a secondary care facility database, resulting in a set of one or more secondary care facility identifiers; and
provide the set of the one or more secondary care facility identifiers to a patient representative;
a facility selection component, operably coupled with the identified facility providing component, configured to receive a patient representative selection corresponding to at least one of the secondary care facility identifiers in the set; and
an auditing storage component, operably coupled with the facility selection component, configured to store the patient representative selection and selection criteria data in an auditing database, at least a portion of the system implemented at least in part via a processing unit.

14. The system of claim 13, comprising a patient data receiving component configured to receive the patient data, the patient data comprising an indication of one or more of:
patient care needs;
a patient payor source;
one or more desired secondary care facility locations;
one or more desired secondary care facility amenities;
a desired secondary care facility rating range; and
a desired secondary care facility cost range.

15. The system of claim 13, comprising a secondary care facility data collecting component configured to collect the secondary care facility data, the secondary care facility data comprising one or more of:
a secondary care facility identifier;
a secondary care facility location;
one or more secondary care facility acceptable payor sources;
one or more secondary care facility services;
one or more secondary care facility clinical capabilities;
one or more secondary care facility amenities;
a secondary care facility cost indicator;
a secondary care facility rating; and
a secondary care facility capacity.

16. The system of claim 13, comprising a user interface component configured to perform one or more of:
provide a patient data input interface;
receive an indication of patient data input;
display the provided set of one or more secondary care facility identifiers to a patient representative;
display facility information associated with the one or more secondary care facility identifiers to a patient representative;
receive an indication of a patient representative selection input;
receive an indication of a patient selection audit request input; and
display audit information associated with the patient selection audit request input.

17. The system of claim 13, comprising one or more of:
a remote network-based application, accessed over a network;
a remote storage component configured to store and retrieve database information for one or more of:
the secondary care facility database; and
the auditing database; and
a local application accessed locally on a computing device.

18. The system of claim 13, comprising an updating component configured to update the secondary care facility data in real-time.

19. The system of claim 13, comprising an auditing component configured to provide an audit of a secondary care facility selection process, comprising retrieving the patient representative selection and selection criteria data.

20. A computer readable medium comprising computer executable instructions that when executed via a processor perform a method for selecting a secondary care facility, comprising:
collecting secondary care facility data and storing the secondary care facility data indexed in a remote secondary care facility database;
receiving patient data using a patient data entry user interface that allows a patient representative to enter the patient data;
comparing received patient data to the secondary care facility data indexed in the secondary care facility database, resulting in a set of one or more secondary care facility identifiers, the respective one or more secondary care facility identifiers linked to the secondary care facility data;
providing the set of one or more secondary care facility identifiers to the patient representative using a patient representative facility selection user interface;
receiving a patient representative selection corresponding to at least one of the secondary care facility identifiers in the set;
transmitting at least a portion of the patient data to a third secondary care facility associated with the patient representative selection, resulting in a patient reservation at the third secondary care facility; and
storing the patient representative selection and selection criteria data in an auditing database, at least a portion of the method implemented at least in part via a processing unit.
